(19) United States
(12) Patent Application Publication
(10) Pub. No.: US 2006/0268743 A1
(43) Pub. Date: Nov. 30, 2006

(54) Information portable terminal apparatus and wireless communication system

(75) Inventor: Yasuharu Yoshida, Kawasaki (JP)

Correspondence Address: KATTEN MUCHIN ROSENMAN LLP, 575 MADISON AVENUE, NEW YORK, NY, 10022-2585, US

(73) Assignee: FUJITSU LIMITED

(21) Appl. No.: 11/231,495

(22) Filed: Sep. 21, 2005

(30) Foreign Application Priority Data
May 24, 2005 (JP) 2005-151067

(51) Int. Cl. H04L 12/28; H04Q 7/24

(52) U.S. Cl. 370/254; 370/338

(57) ABSTRACT

It is an object of the present invention to provide an information portable terminal apparatus, wireless communication system, setting method for a wireless LAN, and a program capable of setting a wireless LAN easily without imposing a complicated operation on a user. A beacon packet is wireless-transmitted from a wireless LAN access point at a predetermined time interval. A portable telephone terminal receives this beacon packet, and acquires a mail address of an information server included in the SSID of the packet. And the portable telephone terminal wireless-transmits to the information server a request mail for acquiring setting information to connect to the wireless LAN using this mail address. The portable telephone terminal performs the settings for the wireless LAN based on the setting information transmitted from the information server.

### CROSS-REFERENCE TO RELATED APPLICATIONS

This application is based upon and claims the benefit of priority from the prior Japanese Patent Application No. 2005-151067, filed on May 24, 2005, the entire contents of which are incorporated herein by reference.

### BACKGROUND OF THE INVENTION

1. Field of the Invention

The present invention relates to an information portable terminal apparatus and a wireless communication system, and more particularly to an information portable terminal apparatus for setting a wireless LAN easily using a portable telephone network.

2. Description of the Related Art

Recently a service for connecting an information portable terminal apparatus, such as a portable telephone and a notebook personal computer to the Internet via a wireless LAN (Local Area Network), is provided on streets and stations.

To use such a service, a plurality of parameters must be set by the information portable terminal apparatus according to the settings of the wireless LAN. These settings have been made manually.

A technology for acquiring the position information of a user terminal using GPS functions, acquiring a plurality of access points close to the current position of the user terminal from a center apparatus based on this information and selecting an access point, and acquiring the parameters necessary to connect to the selected access point from the center apparatus for setting has been disclosed (e.g. Japanese Patent Application Laid-Open No. 2004-235976).

Also a technology for acquiring a hot spot identifier from a hot spot by a wireless terminal, connecting to a setting information management apparatus, receiving the setting information according to the identifier from the setting information management apparatus, and performing wireless connection to the hot spot based on the setting information has been disclosed (e.g. Japanese Patent Application Laid-Open No. 2004-72546).

However manually setting a plurality of parameters increases the number of characters to be input, which imposes a complicated operation on the user. In particular the display screen of a portable telephone is small where the number of input keys is limited, so the operation thereof becomes very complicated.

Also if the information portable terminal apparatus is moved to a different LAN service area, where the settings of the wireless LAN are different, the content of the settings must be changed. And if the settings are changed during maintenance then resetting is required.

In Japanese Patent Application Laid-Open No. 2004-235976, if there are a plurality of access points to be selected, then access points unnecessary for the user may be displayed, and selecting one of the plurality of access points forces the user to undergo a complicated operation. Particularly when the display screen is small, such as the case of a portable telephone, all access points may not be displayed, which makes the operation cumbersome.

In the case of Japanese Patent Application Laid-Open No. 2004-72546, the media access control (MAC) address of the wireless base station is used as the identifier of the hot spot, so if the wireless base station is changed due to failure or other reason, the MAC address also changes, because it is not possible to connect the setup information management, the setting information cannot be acquired. Also, because one setup information management apparatus must manage the setting information of all the hot spots, a burden is forced to the system administrator. Also, because the information to connect to the setting information management apparatus must be held in the wireless terminal, the memory capacity of the wireless terminal increase, and an increase in cost of the wireless terminal is brought about.

### SUMMARY OF THE INVENTION

With the foregoing in view, it is an object of the present invention to provide an information portable terminal apparatus and wireless communication system which allows the setting of a wireless LAN easily without imposing a complicated operation on the user.

To achieve the above object, the present invention provides an information portable terminal apparatus, comprising: first wireless communication unit for receiving periodic information which is wireless-transmitted from a wireless LAN access point at a predetermined time interval; setting unit for acquiring an identifier of an information server included in the periodic information; and second wireless communication unit for wireless-transmitting acquisition request information for requesting the acquisition of setting information to connect to a wireless LAN via the wireless LAN access point to the information server based on the identifier acquired by the setting unit, wherein the setting unit for setting to connect to the wireless LAN based on the setting information wireless-received by the second wireless communication unit in response to the acquisition request.

The present invention is characterized in that the identifier of the information server is included in an area where access point identification information, for identifying each of the wireless LAN access points out of the periodic information, is stored.

Also the present invention is characterized in that the periodic information is a beacon packet, and the identifier of the information server is included in an area where access point identification information, for identifying each of the wireless LAN access points out of the beacon packet, is stored.

Also the present invention is characterized in that the identifier of the information server is a mail address of the information server.

Also the present invention is characterized in that the identifier of the information server is encrypted, and the setting unit decodes the encrypted identifier of the information server from the periodic information received by the first wireless communication unit.

Also the present invention is characterized in that the setting unit controls the second wireless communication unit so as to send said acquisition request information to the information server, with terminal identification information for identifying the each information portable terminal apparatus being included in the acquisition request information.

Also the present invention is characterized in that the setting unit controls the second wireless communication unit so as to send the acquisition request information, with user information of a user who uses the information portable apparatus being further included in the acquisition request information.

Also the present invention is characterized in that the setting information includes the encryption information for encrypting the wireless communication information used between the wireless LAN access point and the second wireless communication unit.

Also the present invention is characterized in that the setting information includes an IP address of the information portable terminal apparatus.

To achieve the above object, the present invention also provides a setting method for a wireless LAN, comprising the steps of: receiving periodic information wireless-transmitted from a wireless LAN access point at a predetermined interval; acquiring an identifier of an information server included in the periodic information; wireless-transmitting acquisition request information for requesting the acquisition of setting information to connect to a wireless LAN via the wireless LAN access point to the information server, based on the acquired identifier; and performing settings to connect to the wireless LAN based on the setting information wireless-received in response to the acquisition request information.

To achieve the above object, the present invention also provides a program for causing a computer to execute the processings of: receiving periodic information wireless-transmitted from a wireless LAN access point at a predetermined interval by first wireless communication unit; acquiring an identifier of an information server included in the periodic information; wireless-transmitting acquisition request information for requesting the acquisition of setting information to connect to a wireless LAN via the wireless LAN access point, to the information server based on the acquired identifier; and performing the settings to connect to the wireless LAN based on the setting information wireless-received by the second wireless communication unit in response to the acquisition request information.

According to the present invention, an information portable terminal apparatus and a wireless communication system for setting a wireless LAN easily without imposing a complicated operation on a user are provided.

### BRIEF DESCRIPTION OF THE DRAWINGS

FIG. 1 is a diagram depicting a configuration example of a wireless communication system to which the present invention is applied;

FIG. 2 is a flow chart including the setting operation to a wireless LAN performed by a portable telephone terminal;

FIG. 3A shows an example of a beacon packet, and FIG. 3B shows an example of the parameters stored in a parameter storage unit; and

FIG. 4 is a diagram depicting another configuration example of a wireless communication system.

### DESCRIPTION OF THE PREFERRED EMBODIMENTS

The preferred embodiments of the present invention will now be described with reference to the drawings.

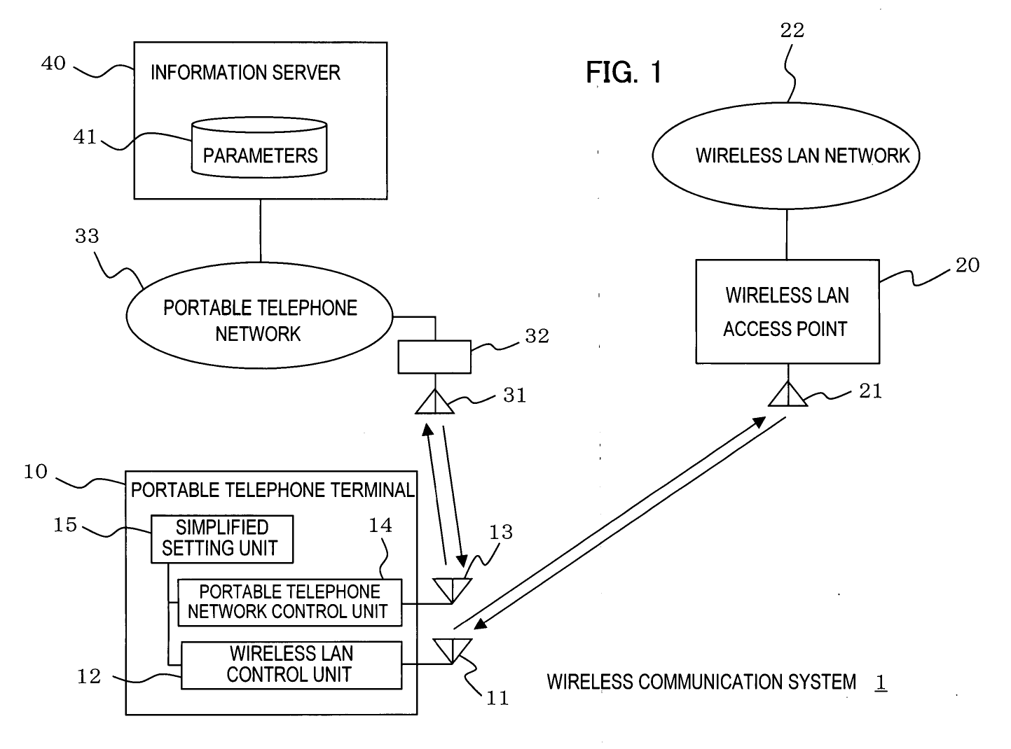

FIG. 1 shows an example of a wireless communication system 1 to which the present invention is applied. The wireless communication system 1 comprises a portable telephone terminal 10 as an example of an information portable terminal apparatus which is movable, wireless LAN access point 20 and information server 40.

The portable telephone terminal 10 comprises an antenna 11 for communicating with the wireless LAN access point 20, a wireless LAN control unit 12 for connecting to the wireless LAN 22, an antenna 13 for communicating with the portable telephone network 33, a portable telephone network control unit 14 for connecting to the portable telephone network 33, and a simplified setting unit 15 for setting the wireless LAN control unit 12 to connect to the wireless LAN 22.

Here the wireless LAN control unit 12 is connected to the antenna 11 and is also connected to the simplified setting unit 15, and the portable telephone network control unit 14 is connected to the antenna 13 and is also connected to the simplified setting unit 15.

The wireless LAN access point 20 is connected to the antenna 21 to communicate with the antenna 11, and is also connected to the wireless LAN 22. The wireless LAN access point 20 relays the data communication between the portable telephone terminal 10 and the wireless LAN 22.

In the present embodiment, the wireless communication between the portable telephone terminal 10 and the wireless LAN access point 20 conforms to IEEE 802.11. Therefore the wireless LAN control unit 12 and the wireless LAN access point 20 both have wireless communication functions according to this standard.

The information server 40 is connected to the portable telephone network 33 and performs data communication with the portable telephone terminal 10 via this portable telephone network 33. And this information server 40 has an internal parameter storage unit 41, where a plurality of parameters, which are the connection information for the portable telephone terminal 10 to connect to the wireless LAN 22 via the wireless LAN access point 20, are stored. Details of these parameters will be described later.

Intermediate equipment 32 for relaying the portable telephone network 33 and the portable telephone terminal 10 is connected to the portable telephone network 33, and the antenna 31 to communicate with the antenna 13 of the portable telephone terminal 10 is connected to this intermediate equipment 32.

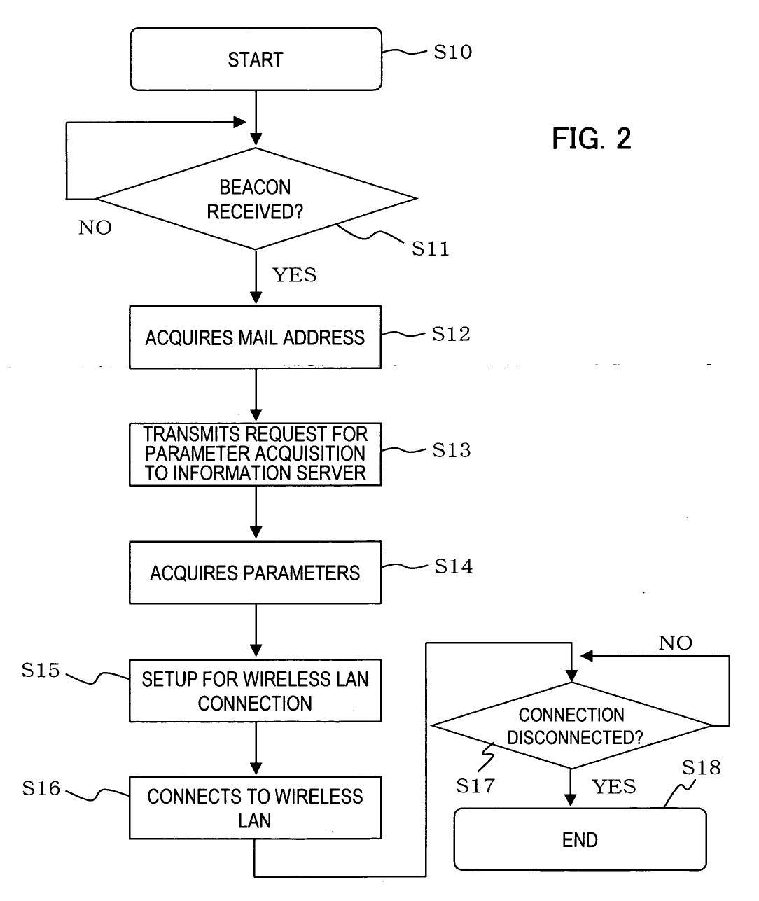

The operation, including setting the wireless LAN 22, in the wireless communication system 1 configured in this way, will now be described. FIG. 2 is a flow chart of the processing to be executed in the portable telephone terminal 10.

When this processing is started (S10), the simplified setting unit 15 of the portable telephone terminal 10 judges whether a beacon packet was received (S11). A beacon packet is a packet which is periodically transmitted from the wireless LAN access point 20 via the antenna 21 in a predetermined range.

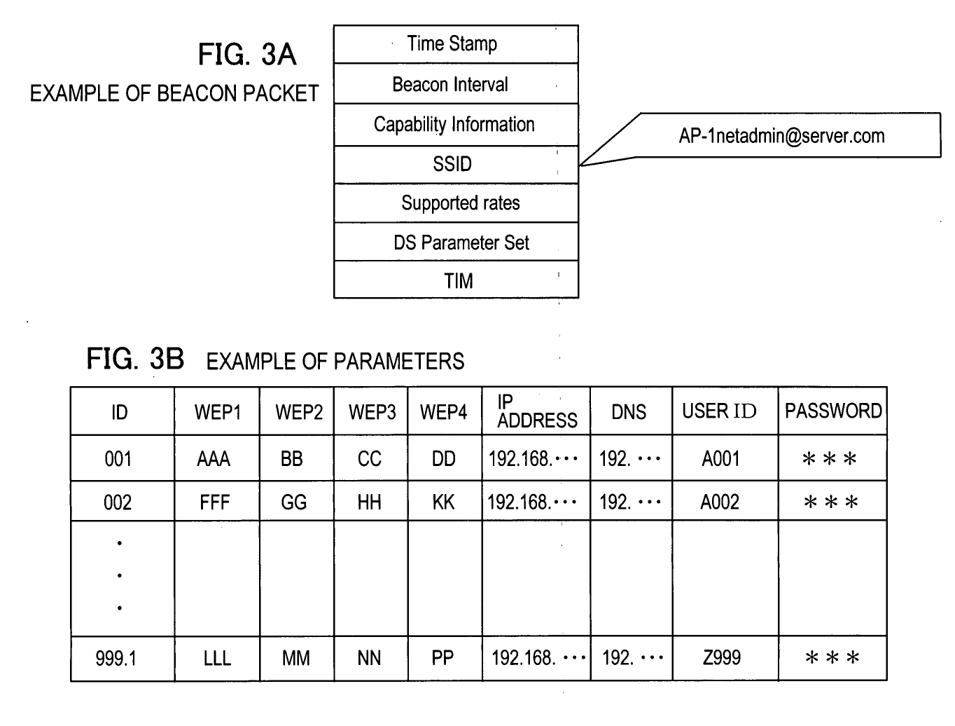

FIG. 3A shows an example of a beacon packet. In this beacon packet, an identifier called the “SSID (Service Set Identifier)” is included. The SSID is an identifier of the network in the wireless LAN 22, which allows the portable terminal 10 having the same SSID to access the wireless LAN 22 via the wireless LAN access point 20.

In the present invention, an identifier to access the information server 40, such as a mail address of the information server 40, is added to this SSID (particularly the ESSID (Extended Service Set IDentifier)). This is for allowing the portable telephone terminal 10 to connect to the information server 40. The identifier of the information server 40 may be the mail address of the information server, for example.

In the case of the example in FIG. 3A, “AP1-netadmin@server.com” is included in the SSID. Of this, “netadmin@server.com” is the mail address of the information server 40. “AP1” is included in this beacon packet as the original SSID, and this is an identifier which is unique to the wireless LAN access point 20.

In the present embodiment, “AP1” is added to the mail address of the information server 40, but only the mail address of the information server 40 may be included in the SSID. This mail address may be encrypted. This is to insure security in this wireless communication system 1.

Referring back to FIG. 2, if the beacon packet is not received by the wireless LAN control unit 12 (NO in S11), the simplified setting unit 15 waits until the beacon packet is received. If the beacon packet is received (YES in S11), the simplified setting unit 15 acquires the mail address of the information server 40 from the beacon packet received by the wireless LAN control unit 12 (S12). If the mail address is encrypted, the simplified setting unit 15 or the wireless LAN control unit 12 decodes it.

Then the simplified setting unit 15 sends a request for parameter acquisition to the information server 40 (S13). Concretely, the simplified setting unit 15 outputs the acquired mail address to the portable telephone network control unit 14, and outputs the control instruction to the portable telephone network control unit 14 to have it send the request for parameter acquisition. The portable telephone network control unit 14 generates a mail based on this information, and sends it to the information server 40. The simplified setting unit 15 may output a control instruction to the portable telephone network control unit 14 such that the ID for identifying the portable telephone terminal 10 is included in this mail, and is sent together.

Then the simplified setting unit 15 acquires the parameters to connect to the wireless LAN 22 from the information server 40 (S14). The information server 40 has the above mentioned parameter storage unit 41 where a plurality of parameters are stored. FIG. 3B shows this example.

In the parameter storage unit 41, an ID to identify each portable telephone terminal 10, 4 types of WEP (Wired Equivalent Privacy) keys, IP address of the portable telephone terminal 10, address of the DNS server, user ID and password are stored. For example, WEP is searched using the ID for identifying the terminal 10 included in the parameter acquisition request as a search key.

Out of these parameters, the WEP key is an encryption key for encrypting the data to be wireless-communicated between the portable telephone terminal 10 and the wireless LAN access point 20. There are 4 types of WEP keys to insure the security of this wireless communication system 1.

The information server 40 sends the plurality of parameters to the portable telephone terminal 10 via the portable telephone network 33 as the response mail. The transmitted mail is received by the portable telephone network control unit 14, and the acquired parameters are input to the simplified setting unit 15.

The information server 40 may perform authentication processing to confirm the validity of the user of the portable telephone terminal 10 before sending these parameters to the portable telephone terminal 10.

For example, a user ID or password is included in the parameter request mail transmitted from the portable telephone terminal 10, and the information server 40 sends a confirmation mail to notify whether this user ID matches with the user ID of the parameter storage unit 41 to the portable telephone terminal 10. The information server 40 sends the mail, including the parameters, when the response mail to this confirmation mail is received from the portable telephone terminal 10.

Then the simplified setting unit 15 performs the settings to connect to the wireless LAN 22 (S15). In other words, the simplified setting unit 15 outputs the acquired parameters to the wireless LAN control unit 12, and the wireless LAN control unit 12 stores them in the setting information area. The setting information area, where the parameters are stored, exists in such a memory as RAM, for example.

Now the simplified setting unit 15 connects the wireless LAN access point 20 based on the parameters which are set (S16). At this time, the portable telephone terminal 10 performs connection authentication with the wireless LAN access point 20. In other words, the portable telephone terminal 10 sends information for a connection request.

This information includes a WEP key, user ID and password, out of the acquired parameters, and if this information matches the WEP key, etc. being stored, the wireless LAN access point 20 outputs the information for connection completion. A connection completes when the portable telephone terminal 10 receives the information for the connection completion. At this time, the content to indicate the connection completion, for example, is displayed on the display screen of the portable telephone terminal 10. By this display content, the user knows that connection to the wireless LAN 22 is enabled.

And hereafter the portable telephone terminal 10 can connect to the wireless LAN 22 via the wireless LAN access point 20.

When the portable telephone terminal 10 disconnects the connection to the wireless LAN 22 by turning the power OFF, for example, (YES in S17), a series of processings ends (S18), and if the connection is not disconnected, then connection to the wireless LAN 22 is maintained (NO in S17).

In this way, the user merely performs an operation for sending a request mail to acquire parameters, and performs a screen operation to confirm the connection to the wireless LAN 22. Therefore when setting for connecting to the wireless LAN 22 is performed, it is unnecessary to input many characters, so settings can be performed simply, without imposing an operation burden on the user. Also input mistakes of setting parameters and a connection failure to the wireless LAN 22 can be decreased. Also the mail address for connecting to the information server 40 can be received from the wireless LAN access point 20, and this address itself need not be stored in the portable telephone terminal 10, so the memory capacity can be decreased and the cost of the terminal 10 itself can be decreased.

The parameters shown in FIG. 3 are the part of the parameters, and the parameters for power management and performance adjustment may be used in addition to the parameters for security setting, such as the WEP key, user ID, IP address and DNS address.

Examples are the beacon interval which indicates the time interval when beacon packets are transmitted, and a fragment threshold, which indicates the threshold of data volume to be transmitted from the wireless LAN access point 20. By freely setting these time parameters, and other parameters, by the portable telephone terminal 10, the power consumption of the terminal 10 itself can be minimized. For example, by setting the beacon interval to a high value to increase the time for the power of the wireless LAN control unit 12 to remain OFF, power consumption is minimized.

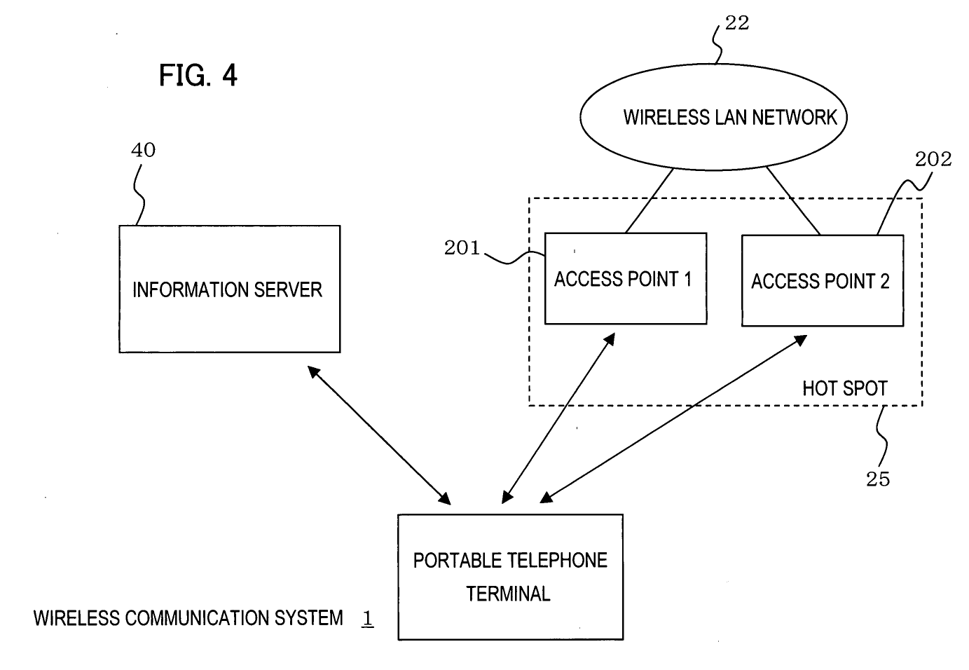

In the above example, parameters for one wireless LAN access point 20 are managed by one information server 40, but as FIG. 4 shows, a plurality of wireless LAN access points 201 and 202 may exist in one hot spot 25, so that the parameters for these access points 201 and 202 are controlled by one information server 40. In other words, this is a case of a wireless communication system 1 where the information server 40 exists for each hot spot 25. One information server 40 may manage the parameters for a unit of a plurality of hot spots 25. In these cases as well, the types of parameters stored in the information server 40 are the same as the above mentioned example.

However one information server 40 managing parameters for all the hot spots imposes a burden on the system administrator of the information server 40, so this is not preferable.

The above example uses the IEEE 802.11 standard for wireless communication between the portable telephone terminal 10 and the wireless LAN access point 20. Certainly IEEE 802.1b, IEEE 802.11a and Bluetooth may be used instead. And in these cases as well, the functional effects, the same as the above example, are exhibited.

In the above examples, a WEP key was described for the encryption key, but WPA(Wi-fi Protected Access), where the key is updated in a predetermined time, may be used instead.

The above examples were described using the portable telephone terminal 10 as the information portable terminal apparatus. Certainly a notebook personal computer or a PDA (Personal Digital Assistant), for example, exhibit the same function effects as the above examples.

What is claimed is:

1. An information portable terminal apparatus, comprising:
first wireless communication unit for receiving periodic information which is wireless-transmitted from a wireless LAN access point at a predetermined time interval;
setting unit for acquiring an identifier of an information server included in said periodic information; and
second wireless communication unit for wireless-transmitting acquisition request information for requesting the acquisition of setting information to connect to a wireless LAN via said wireless LAN access point to said information server based on said identifier acquired by said setting unit, wherein
said setting unit for setting to connect to said wireless LAN based on said setting information wireless-received by said second wireless communication unit in response to said acquisition request.

2. The information portable terminal apparatus according to claim 1, wherein the identifier of said information server is included in an area where access point identification information for identifying each of said wireless LAN access points out of said periodic information is stored.

3. The information portable terminal apparatus according to claim 1, wherein said periodic information is a beacon packet, and the identifier of said information server is included in an area where access point identification information for identifying each of said wireless LAN access point out of said beacon packet is stored.

4. The information portable terminal apparatus according to claim 1, wherein the identifier of said information server is a mail address of said information server.

5. The information portable terminal apparatus according to claim 1, wherein the identifier of said information server is encrypted, and said setting unit decodes the encrypted identifier of said information server from said periodic information received by said first wireless communication unit.

6. The information portable terminal apparatus according to claim 1, wherein said setting unit controls said second wireless communication unit so as to send said acquisition request information to said information server, with terminal identification information for identifying said each information portable terminal apparatus being included in the acquisition request information.

7. The information portable terminal apparatus according to claim 6, wherein said setting unit controls said second wireless communication unit so as to send said acquisition request information, with user information of a user who uses said information portable terminal apparatus being further included in the acquisition request information.

8. The information portable terminal apparatus according to claim 1, wherein said setting information includes encryption information for encrypting wireless communication information used between said wireless LAN access point and said second wireless communication unit.

9. The information portable terminal apparatus according to claim 1, wherein said setting information includes an IP address of said information portable terminal apparatus.

10. A setting method for a wireless LAN, comprising the steps of:
receiving periodic information wireless-transmitted from a wireless LAN access point at a predetermined interval;
acquiring an identifier of an information server included in said periodic information;
wireless-transmitting acquisition request information for requesting the acquisition of setting information to connect to a wireless LAN via said wireless LAN access point to said information server, based on said acquired identifier; and
performing the settings to connect to said wireless LAN based on said setting information wireless-received in response to said acquisition request information.

11. A program for causing a computer to execute the processings of:
receiving periodic information wireless-transmitted from a wireless LAN access point at a predetermined interval by first wireless communication unit;
acquiring an identifier of an information server included in said periodic information;
wireless-transmitting acquisition request information for requesting the acquisition of setting information to connect to a wireless LAN via said wireless LAN access point, to said information server based on said acquired identifier; and
performing the settings to connect to said wireless LAN based on said setting information wireless-received by said second wireless communication unit in response to said acquisition request information.
